(19) United States
(12) Patent Application Publication
(10) Pub. No.: US 2006/0149731 A1
(43) Pub. Date: Jul. 6, 2006

(54) System and method for deriving affinity relationships between objects

(76) Inventors: Andrew Lewis Schirmer, Andover, MA (US); Vaughn Theodore Rokosz, Newton, MA (US)

Correspondence Address: PILLSBURY WINTHROP SHAW PITTMAN, LLP, P.O. BOX 10500, MCLEAN, VA, 22102, US

(21) Appl. No.: 11/028,576

(22) Filed: Jan. 5, 2005

(51) Int. Cl. G06F 17/30

(52) U.S. Cl. 707/6

(57) ABSTRACT

A system and method are provided for deriving affinity relationships between objects. A plurality of objects may be stored in a database. When two or more of these objects interact, the system and method may create an entry in a database defining the interaction. A counter may be incremented each time an interaction occurs between a pair of objects. If the counter exceeds a predefined threshold, the objects in the interacting object pair may be classified as having an affinity for each other.

### CROSS REFERENCE TO RELATED APPLICATIONS

This application is related to the following applications: “System and Method for Calculating a User Affinity”, Ser. No. 10/044,922, filed Jan. 15, 2002; “System and Method for Publishing a Person's Affinities”, Ser. No. 10/044,923, filed Jan. 15, 2002; and “System and Method for Mining a User's Electronic Mail Message to Determine the User's Affinities”, Ser. No. 10/044,921, filed Jan. 15, 2002.

### FIELD OF THE INVENTION

The invention relates to a system and method of deriving an affinity relationship between two or more objects based on their interaction with each other.

### BACKGROUND OF THE INVENTION

Modern computer architectures and applications are commonly “object-based”, meaning the system information is represented as one or more instances of one or more types of objects. The objects have one or more types of data comprised of one or more instances of the type. For example, a database application representing a directory of information about people might have architecture with a person object that contains data items for a person's name, street address, city, state, zip code, and phone numbers. To contain information, the application creates and maintains instances of that person object, usually one for each person, with instance data for the object's fields.

Different object types may have completely different data properties or they may share data properties. When data properties are shared, it is possible to create relationships between two objects based on a shared instance of a common data type. This is commonly known as a relational computing model. For example, a clothing database may have a “shirt” object type and a “slacks” object type, each of which has a common data property for color. If a particular instance of a shirt object and a particular instance of a slacks object both have the color property with the value “blue”, the two items can be linked together in a relationship, which in this case might be called “matching”. Both of these particular objects are blue. Once the relationship has been established, it can be applied in useful ways to provide additional functionality, such as recommending the particular shirt to a customer who is buying that particular pair of slacks.

While this mechanism works for establishing simple atomic relationships like the one in the example, it is inadequate for establishing reliably meaningful relationship. Just because two pieces of clothing are blue doesn't mean they match well enough to be worn together. It would be desirable to have a relationship tracking mechanism which tracks the degree of an object's interaction with other objects. This would offer a more reliable indication of a connection between the objects.

Some systems attempt to do this in relation to products and people. If a first person's purchases are similar to the purchases of a second person, a recommendation of the first person's other purchases may be made to the second person. One drawback to systems of this type is that they only take advantage of explicit expressions of interest to suggest possible other implicit relationships. Some systems have also attempted to define relationships between people and topics, but have been unable to derive meaningful relationships between other object types.

These and other drawbacks exist.

### SUMMARY OF THE INVENTION

According to various embodiments of the present invention, a mechanism for deriving affinity relationships between objects is provided. As used herein, affinity refers to the level of interaction between objects. The present invention provides a system and method that calculates an affinity score based on the interaction between objects. The system and method may be used to discover relationships that may otherwise be undetected by building on any type of implicit relationship and using thresholds to achieve a higher level of confidence about the proposed relationship. Extended relationship information may be obtained by aggregating affinity results for one or more object properties. By deriving affinity relationships, patterns of information may emerge, assisting users in making various types of decisions.

The system may include at least some or all of the following components. A discovery server may be provided for analyzing interactions between objects to identify relationships and calculate an affinity score. An objects database may be provided for storing one or more object instances and their associated properties for a particular organization. A relationship database may be provided for storing affinity relationship object pairs.

The discovery server may include one or more modules. For example, an object monitoring module may be provided for observing the objects in an objects database to determine when an interaction occurs between two objects. An interaction assessment module may be provided for determining whether an interaction has previously occurred between an object pair, and for updating the relationship database whenever an interaction occurs. An affinity calculation module may be provided for determining whether the number of interactions between a pair of objects has exceeded a certain threshold, thus indicating that the objects have an affinity for each other.

According to some embodiments of the invention, a user interface may be provided, enabling a user to use the calculated affinity information. The user interface may present a search query enabling the user to search for a particular property. Results may be provided indicating objects having an affinity relationship associated with the selected property. The user may use the affinity relationship to discover additional resources related to the selected property.

An object monitoring module may determine when an interaction has occurred between objects and may retrieve information about the interaction. The interaction assessment module may then consult the relationship database to determine if an interaction has previously occurred between the object pair. If so, a counter for the object pair is incremented. If not, a new entry is added. The affinity calculation module may monitor each counter to determine if the counter exceeds a predefined threshold. Once a counter has exceeded the predefined threshold, a flag may be set indicating that the objects have an affinity for each other.

According to some embodiments of the invention, relationship information may be extended by aggregating on a particular property of an object. A common property may be shared by more than one object. By aggregating on a particular shared property, additional sources of information may be obtained.

These and other objects, features, and advantages of the invention will be apparent through the detailed description of the preferred embodiments and the drawings attached hereto. It is also to be understood that both the foregoing general description and the following detailed description are exemplary and not restrictive of the scope of the invention.

### BRIEF DESCRIPTION OF THE DRAWINGS

FIG. 1 illustrates a sample objects table, according to various embodiments of the invention.

FIG. 2 illustrates a system diagram, according to various embodiments of the invention.

FIG. 3 illustrates a block diagram of a discovery server, according to various embodiments of the invention.

FIG. 4 illustrates a flowchart for determining an affinity relationship between objects, according to various embodiments of the invention.

FIGS. 5A and 5B illustrate graphical user interfaces, according to various embodiments of the invention.

### DETAILED DESCRIPTION OF PREFERRED EMBODIMENTS

A system and method are provided for deriving affinity relationships between a plurality of objects. As the objects interact with each other, the system learns which objects interact most. According to various embodiments of the invention, an affinity score may be kept for each object indicating its level of interaction with other objects across an organization. Objects may vary depending on the type of organization. For example, in a retail store, objects may include items of clothing such as shirts and pants, point of service objects such as a cash register and a scanner, and/or any other objects commonly used in retail establishments. For a corporate office, objects may include, for example, printers, computers, scanners, copiers, documents, and/or other office related objects.

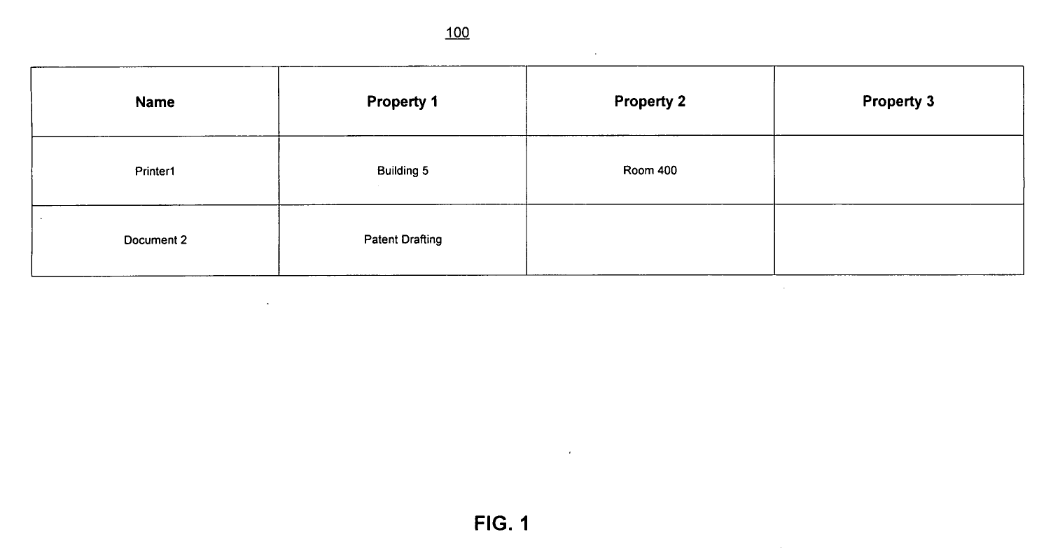

FIG. 1 illustrates, by way of example, a table 100 of objects and properties that may be found in an office. As illustrated, each instance of an object may have associated with it one or more properties. For example, object “Printer1” has associated with it a property called building having a value of “Building 5”, and a property room having a value of “Room 400.” An object “Document2” has associated with it a property topic having a value “Patent Drafting.” Properties may be manually assigned to an object when creating an object database. According to some embodiments of the invention, properties may be dynamically associated with an object based on embedded metadata. For example, a document may include metadata defining keywords, the author, the title, and or other values, which may be used to define a property such as topic.

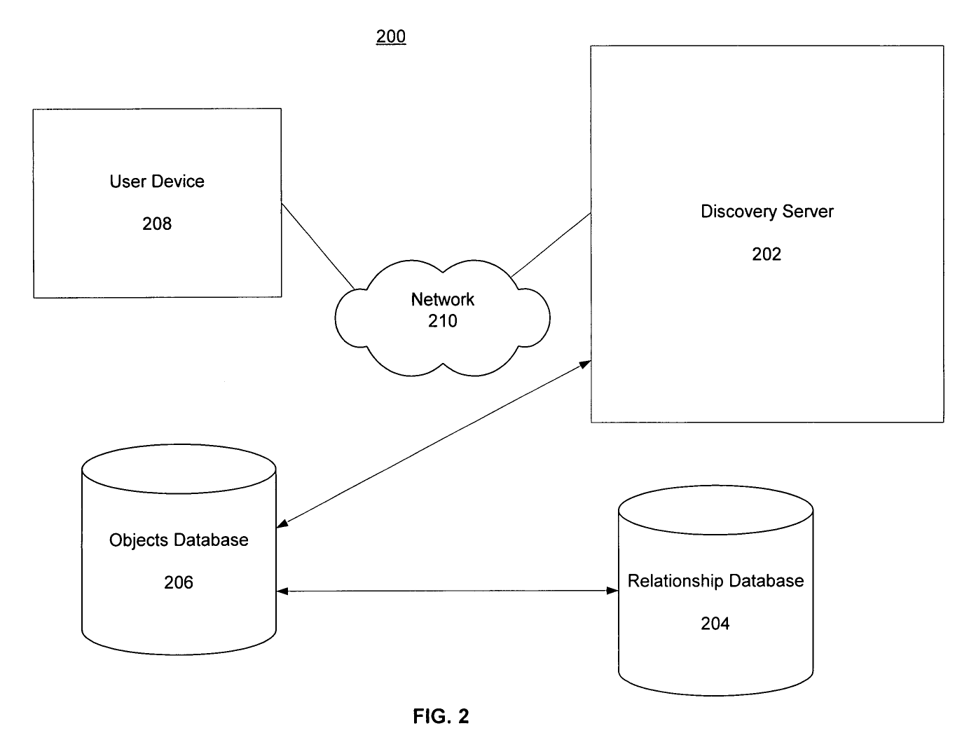

FIG. 2 illustrates a system 200 for monitoring objects and deriving an affinity relationship based on object interactions, according to various embodiments. System 200 may comprise a discover server 202, a relationship database 204, and an objects database 206. A user device 208 may be provided for accessing and interacting with discovery server 202. As illustrated, a discovery server 202 may be provided that monitors interactions between instances of objects and analyzes the interactions to identify relationships. An objects database 206, communicatively coupled to discovery server 202, may be provided to store one or more objects associated with a particular organization. Objects database 206 may provide a simple list of each instance of an object and the one or more properties associated with each object.

System 200 may also employ a relationship database 204 that may also be communicatively coupled to discovery server 202. Relationship database 204 may keep track of relationships between objects. Entries may be placed in relationship database 204 for each object interaction pair. Entries in relationship database 204 may include, for example, a name of each object in the pair, the properties associated with the objects, the action that occurred between the two objects, a counter for keeping track of the number of interaction, and/or other information. According to some embodiments, a separate entry may be maintained for each type of action that occurs between an object pair. In other embodiments, all interactions between an object pair are maintained in a single entry. Additionally, in accordance with some embodiments, a timestamp may be provided indicating the last time an interaction has occurred between two objects. A field may be provided for indicating whether an affinity relationship exists between two objects. According to some embodiments of the invention, a user device 208 may access discovery server 202, enabling a user to search for relationship information. User device 208 may access discovery server 202 over any known network, such as network 210.

Activity metrics may be tracked for each object interaction. For example, discover server 202 may track activity metrics for a document object, such as when a document is created, modified, opened, printed, emailed and/or otherwise operated on. These activity metrics may be used to infer connections between the objects as they interact with each other. For example, if a computer located in room 12 of building A is used to create a document regarding programming, a connection between that computer and documents about programming may be inferred. This information may then be collected and stored in relationship database 204.

According to some embodiments of the invention, certain activities may be identified or regarded as activities of interest. When an interaction occurs, the system may be configured to record details about only those activities considered of interest. Alternatively, in other embodiments, all activities may be monitored and recorded.

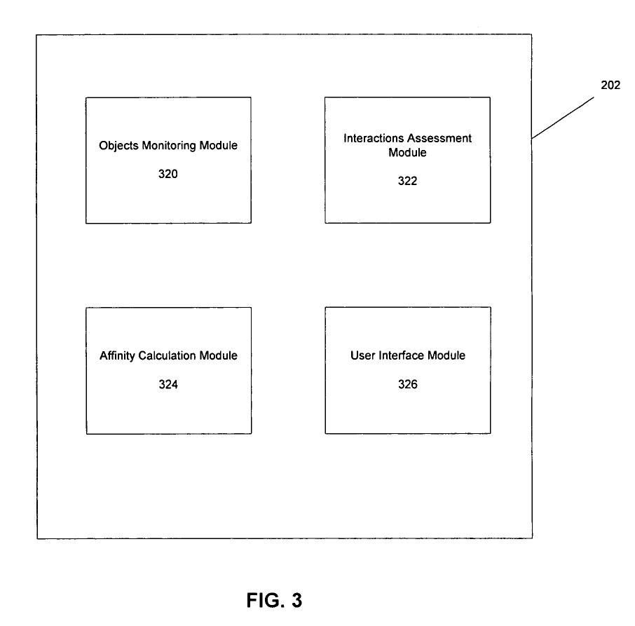

Discovery server 202 may also include one or more modules, as illustrated in FIG. 3. For example, an object monitoring module 320 may be provided that observes objects stored in objects database 206. Object monitoring module 320 may observe and analyze all objects in database 206, or may alternatively monitor only a defined set of objects. When objects interact, object monitoring module 320 may annotate the names of the interacting objects, the time of the interaction, the type of interaction that occurred, and/or other associated information. It will be appreciated that interactions may vary, depending on the type of objects stored in objects database 206. For example, if objects database 206 stores objects related to a typical office environment, such as printer and document objects, interactions may include printing, viewing, editing, creating, and/or other interactions.

As depicted in FIG. 3, an interaction assessment module 322 may be provided within discovery server 202. Interaction assessment module 322 may interface with object monitoring module 320 and metrics database 204 to report the interaction. Information collected by object monitoring module 320 may be organized and presented, by interaction assessment module 322, to metrics database 204. Interaction assessment module 322 may first determine whether an entry has already been placed in metrics database 204 for the interaction between the pair of objects. If an entry has not been entered, a new entry may be placed by interaction assessment module 322. A counter may also be provided for each entry and incremented each time a new interaction occurs between two objects. According to some embodiments of the invention, entries may be removed if no interaction has occurred within a defined time period. This enables interaction records to remain current and to reflect the recent status of the objects.

As illustrated in FIG. 3, an affinity calculation module 324 may be provided within discovery server 202 that calculates an affinity score based on a relationship between two objects. An affinity score may provide a numerical representation of how often an object interacts with another object. According to various embodiments of the invention, affinity calculation module 324 may monitor the relationship counters stored in relationship database 204. Affinity calculation module 324 may also determine whether the number of interactions for a pair of objects exceeds a predefined threshold. In such case, if the number of interactions exceeds the predetermined threshold, affinity calculation module 324 may present indicia to relationship database 204 indicating an affinity between the two objects. According to some embodiments of the invention, affinity scores may be assigned different levels based on the number of interactions. For example, a first threshold may indicate a low level affinity while subsequent thresholds may be provided to indicate higher affinity levels.

A user interface module 326 may be provided within discovery server 202 that manages a connection to a user device, such as user device 208. User interface module 326 may receive search request from user device 208. User interface module 326 may query relationship database 204 based on search criteria entered at user device 208. User interface module 326 may then present to user device 208 search results in a user readable format.

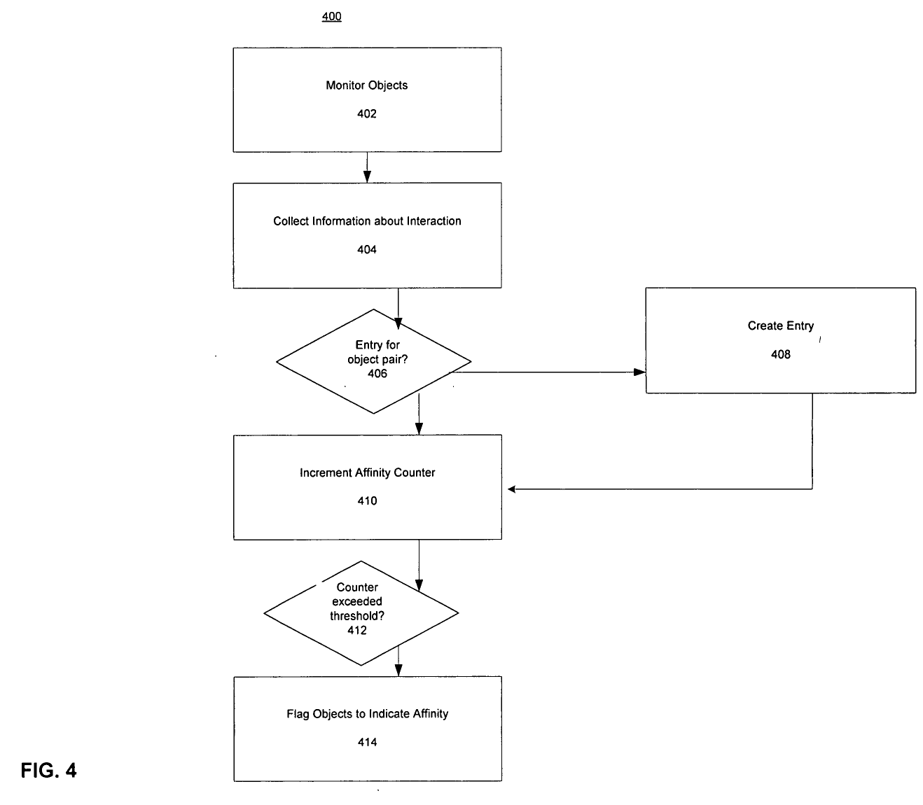

FIG. 4 illustrates a process 400 configured to derive affinity relationships, according to various embodiments of the invention. As illustrated at operation 402, an object monitoring module may continuously monitor objects stored in one or more objects databases to determine whether an interaction has occurred among the objects. When an interaction occurs, information about the interaction objects may be collected, as illustrated at operation 404. The collected information may include, for example, the name of the objects, any properties associated with the objects, the action that took place between the objects, the time of the interaction, and/or other information.

At operation 406, a check is performed to determine whether an entry already exists in a relationship database for an interaction between the object pair. Each time an object interacts with another object for the first time, an entry may be placed in a relationship database. The entry may include the object names, the properties associated with the objects, the type of interaction that occurred, and/or other information. An affinity counter may also be created for each entry. Each subsequent time an interaction occurs between the objects, the counter may be incremented. As illustrated at operation 408, an entry is created if no entry currently exists. If the entry already exists, the affinity counter is incremented, as illustrated at operation 410.

A single or even a small number of interactions between two objects does not necessarily indicate a meaningful relationship between the objects. For example, a document about a certain topic may be printed at a printer different than the usual printer because the usual printer is temporarily offline. Thus, the isolated interaction between the document and the temporary printer do not necessarily indicate a meaningful relationship. Thresholds may be used to assign an affinity relationship to those objects that interact regularly. Accordingly, as illustrated at operation 412, a check may be performed to determine if the affinity counter for the object pair exceeds a predefined threshold. If the threshold has not been exceeded, monitoring of the objects may continue. If the threshold has been exceeded, the entry for the object pair in the relationship database may be flagged to indicate an affinity relationship between the objects, as illustrated at operation 414. According to some embodiments of the invention, multiple thresholds may be used to provide different levels of affinity. For example, an affinity score may be assigned indicating which threshold the object pair has exceeded. A higher score may indicate a higher affinity.

According to some embodiments of the invention, observed interactions may be viewed in the aggregate based on a shared attribute of one of the interacting objects. For example, a document object may be aggregated on attributes such as topic, author, printing location, storage location, and/or other attributes. From this aggregation, extended relationship information may be obtained. For example, aggregation on a storage location, such as a building number, may indicate that computers in a particular building have an affinity for a certain topic.

According to some embodiments of the invention, the information stored in a relationship database may be queried to find resources related to a certain topic. For example, a user may wish to find an expert on programming languages. A search of the relationship database may indicate that objects about programming languages are often printed at a particular printer. Thus, the user can frequently visit the printer location to read documents about programming or to meet people who frequently print documents about programming. According to some embodiments of the invention, a graphical user interface (GUI) may be provided, enabling a user to query a relationship database.

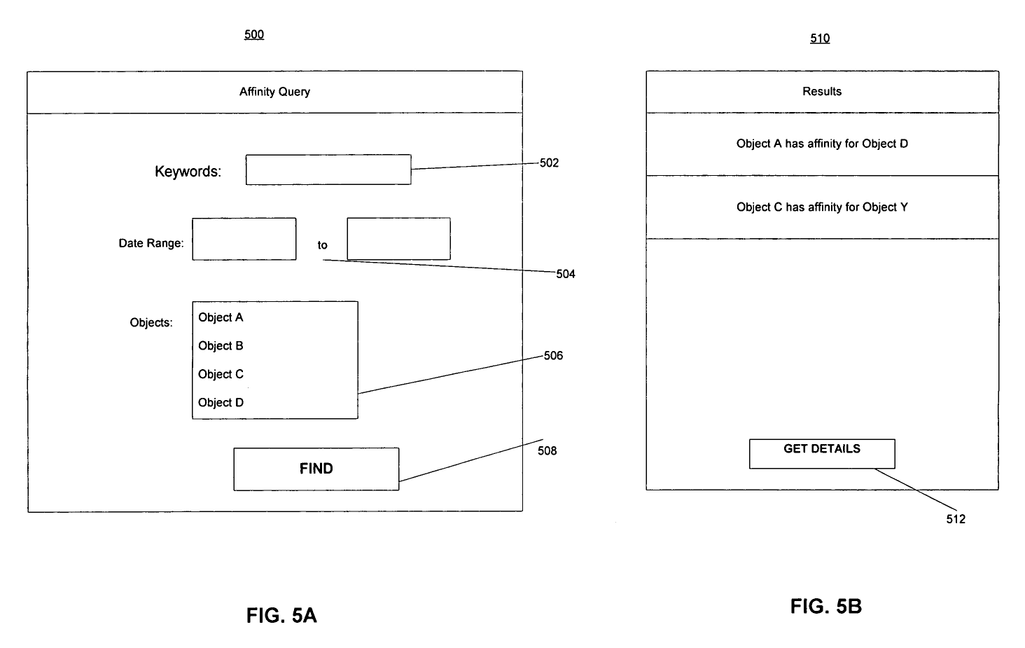

FIG. 5A illustrates an example of a GUI 500 that may be used to perform queries, according to some embodiments of the invention. GUI 500 may include a keywords field 502 for accepting one or more keywords to be searched. For example, a user wishing to find information about programming resources may enter a keyword “programming”. Date fields 504 may be included to restrict the search to a specified data range. GUI 500 may include a menu 506 listing all monitored objects. If a user knows one or more particular objects that are of interest, the user may select those objects from menu 506 and be presented with search results listing affinity information for the selected objects. Other fields may be presented, as would be apparent. A user may select “Find” button 508 to initiate the search.

FIG. 5B illustrates an example of a results list 510 that may be returned to a user. Results list 510 may include entries indicating objects and affinities related to the entered search criteria. For example, a search using the keyword programming may return results indicating that certain printers, computers, people, and or other objects have an affinity for documents or other objects related to programming. According to some embodiments of the invention, a user may select an entry from the results list to obtain additional information about the objects by selecting a “Get Details” button 512. Other methods of selecting an entry may be used as would be apparent. For example, selecting an entry may present the user with the object properties, such as the location, the number of interactions that occurred between the objects, the times of the interactions, and/or other information. The user may then use this information to find an expert or additional materials related to their search criteria.

Other embodiments, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. A method for deriving affinity relationships for one or more of a plurality of objects comprising:
monitoring one or more of the plurality of objects to determine whether two of the plurality of objects interact;
in response to determining that two of the plurality of objects have interacted:
collecting data defining the interaction;
determining whether an entry has been created in a relationship database for the interacting objects and wherein an entry has not been created, creating said entry; and
incrementing an affinity counter located in said entry to keep track of a number of interactions between two of said plurality of objects;
wherein said affinity relationship is based on said affinity counter.

2. The method of claim 1 wherein said collected data includes a name for each of said two interacting objects and one or more of a time the interaction occurs, a type of interaction, and one or more properties associated with each of said two objects.

3. The method of claim 1 further comprising:
determining whether the affinity counter exceeds a predefined threshold; and
wherein the affinity counter exceeds the predetermined threshold, providing indicia in said entry in said relationship database indicating the objects have an affinity for each other.

4. The method of claim 1 wherein each entry includes a timestamp indicating a last interaction and wherein the method further comprises:
determining whether a predetermined time period has elapsed since the last interaction; and
wherein said predetermined time period has elapsed, resetting said affinity counter.

5. The method of claim 1 further comprising:
examining each entry in said relationship database;
determining whether two or more objects in said relationship database share a common property; and
wherein two or more objects in said relationship database share a common property, defining an aggregate affinity relationship among said two or more objects sharing a common property.

6. The method of claim 1 further comprising:
defining a set of one or more objects from said plurality of objects that are of interest; and
monitoring said defined set of objects to determine whether two or more of said defined set of objects interact.

7. The method of claim 1 further comprising:
defining a set of one or more interactions that are of interest, wherein said one or more interactions occur among said plurality of objects; and
collecting data associated with two or more objects when said two or more objects interact via one of said one or more actions that are of interest.

8. The method of claim 1 wherein said objects database includes one or more metadata attributes describing each of said objects.

9. The method of claim 8 further comprising:
determining whether two or more of said plurality of objects share a common metadata attribute; and
wherein two or more of said plurality of objects share a common metadata attribute, assigning said two or more objects to an object class.

10. The method of claim 9 further comprising:
determining whether an interaction occurs between one of said plurality of objects stored in said objects database and said object class;
wherein an entry interaction has occurred, updating an entry in said relationship database indicating said interaction.

11. The method of claim 10 wherein updating said entry includes:
wherein an entry has not been created, creating said entry; and
updating an affinity counter.

12. The method of claim 1 wherein the plurality of objects are stored in an objects database and wherein said objects database includes a name for each object and one or more properties associated with each object.

13. A system for deriving affinity relationships for one or more of a plurality of objects comprising:
an objects database configured to store said plurality of objects and one or more properties associated with each of said plurality of objects;
a discovery server configured to determine whether an interaction has occurred between two of said plurality of objects, wherein upon making a determination that an interaction has occurred, the discovery server annotates at least an object name and the one or more properties associated with the object for said two interacting objects; and
a relationship database configured to store one or more entries defining said affinity relationship between said two interacting objects, wherein said affinity relationship is based on at least a number of interactions that have occurred between said two objects.

14. The system of claim 13 wherein said discovery server comprises:
an interaction assessment module for determining whether an entry has been made in said relationship database for said two interacting objects, and wherein an entry has not been made, creating an entry; and
an affinity calculation module, said affinity calculation module configured to maintain a plurality of counters wherein one of said plurality of counters corresponds to each of said one or more entries in said relationship database.

15. The system of claim 13 wherein said one or more entries defining said affinity relationship includes a name field for each of said two interacting objects and one or more of a time the interaction occurred, a type of interaction, and one or more properties associated with each of said two interacting objects.

16. The system of claim 13 further comprising a user interface module configured to provide a graphical user interface wherein said graphical user interface enables a user to perform a query of said relationship database.

17. A computer implemented system for deriving affinity relationships for one or more of a plurality of objects comprising:
means for monitoring one or more of the plurality of objects, wherein the plurality of objects are stored in an objects database and wherein said objects database includes a name for each object and one or more properties associated with each object, to determine whether two of the plurality of objects interact;
in response to a determination that two of the plurality of objects have interacted:
means for collecting data defining the interaction;
means for determining whether an entry has been created in a relationship database for the interacting objects and wherein an entry has not been created, creating said entry; and
means for incrementing an affinity counter located in said entry wherein said affinity counter keeps track of a number of interaction that occur between two or said plurality of objects.

18. The system of claim 17 further comprising:
means for determining whether the affinity counter exceeds a predefined threshold; and
wherein the affinity counter exceeds the predetermined threshold, means for providing indicia in said entry in said relationship database indicating the objects have an affinity for each other.

19. The system of claim 17 further comprising:
means for examining each entry in said relationship database;
means for determining whether two or more objects in said relationship database share a common property; and
wherein two or more objects in said relationship database share a common property, means for defining an aggregate affinity relationship among said two or more objects sharing a common property.
